(19) United States
(12) Patent Application Publication
(10) Pub. No.: US 2013/0305893 A1
(43) Pub. Date: Nov. 21, 2013

(54) MULTIFUNCTIONAL COOKING UTENSIL

(71) Applicant: QUIRKY INC., New York, NY (US)

(72) Inventors: Ben Kaufman, New York, NY (US); Faris Elmasu, Brooklyn, NY (US); Benjo Manuel, Shenxhen (CN); Nicholas Oxley, Brooklyn, NY (US)

(73) Assignee: QUIRKY INC., New York, NY (US)

(21) Appl. No.: 13/773,821

(22) Filed: Feb. 22, 2013

Related U.S. Application Data
(60) Provisional application No. 61/647,162, filed on May 15, 2012.

(51) Int. Cl. A47J 43/28; B26D 3/00

(52) U.S. Cl. CPC A47J 43/288; B26D 3/00; A47J 43/283
USPC 83/30; 7/112; 7/113; 83/13; 294/24

(57) ABSTRACT

An exemplary aspect comprises an apparatus comprising: (a) a first handle component comprising a first end and a second end; and (b) a second handle component comprising a third end and a fourth end, wherein the first end is connected to the third end via a spring clip, wherein the second end is connected to a first spatula component, wherein the fourth end is connected to a second spatula component, and wherein the first handle component is operable to be locked to the second handle component. In one or more exemplary embodiments: (1) the second spatula component and the second handle component comprise a retractable fork component; (2) the first spatula component comprises a serrated edge; and (3) the first handle component is operable to be locked to the second handle component via a sliding member.

### CROSS-REFERENCE TO RELATED APPLICATIONS

This application claims priority to U.S. Provisional Patent Application No. 61/647,162, filed May 15, 2012, entitled “Multifunctional Cooking Utensil.” The entire contents of the above-referenced application are incorporated herein by reference.

### Introduction

Grilling meat, fish, vegetables, and other food on a barbeque grill is a popular cooking method. Typically, the food is placed on the barbeque grill and cooked for a certain period of time. To keep the food moist and flavorful, turning of the food while grilling is required. Further, when fully cooked, the food needs to be lifted and removed from the barbeque grill. Because the grill emits intense heat, a user cannot simply grip and turn or lift the food with his or her bare hands. To assist the user with gripping, turning, and lifting, multiple barbeque tools/utensils and accessories are available on the market.

However, conventional barbeque tools usually are designed to serve only a single primary function. The most commonly used barbeque tools are a pair of tongs (for gripping and flipping food of various sizes, such as meat, vegetables, etc.), a fork (for forking and flipping food, such as chops and hot dogs, and for holding the food securely while carving), and a spatula (for sliding under and lifting the food—in particular, more delicate food, such as a fish fillet). Often, such barbeque tools are sold together, as a barbeque set, for example, a pair of tongs, a fork, and a spatula. Barbeque sets may also include other tools/utensils and accessories, such as a knife, a basting brush, a cleaning brush, a bottle opener, a thermometer, etc.

Consequently, a typical user ends up owning and using multiple barbeque tools. Significant storage space may required to store such multiple barbeque tools. Further, while used for grilling, such tools often crowd the working surface and require the user to switch between different tools, making the grilling process awkward and hectic. Also, when multiple barbeque tools are used, the user spends a significant amount of time cleaning such tools.

An exemplary aspect comprises an apparatus comprising: (a) a first handle component comprising a first end and a second end; and (b) a second handle component comprising a third end and a fourth end, wherein the first end is connected to the third end via a spring clip, wherein the second end is connected to a first spatula component, wherein the fourth end is connected to a second spatula component, and wherein the first handle component is operable to be locked to the second handle component.

In one or more exemplary apparatus embodiments: (1) the second spatula component and the second handle component comprise a retractable fork component; (2) the first spatula component comprises a serrated edge; (3) the first handle component is operable to be locked to the second handle component via a sliding member; (4) the sliding member has a first locking position and a second locking position; and (5) when the sliding member is in the first locking position, the fork component is in an extended position, and when the sliding member is in the second locking position, the fork component is in a retracted position.

One or more exemplary method embodiments comprise one or more of:

(1) when the first handle component is not locked to the second handle component: positioning the apparatus such that a food item is located between the first spatula component and the second spatula component; compressing the first handle component and the second handle component together, so that the first spatula component and the second spatula component press against the food item with sufficient force to hold the food item; and releasing pressure on the first handle component and the second handle component in an amount sufficient to release the food item from the first spatula component and the second spatula component;

(2) when the first handle component is locked to the second handle component: positioning the first and second spatula components under a food item; and removing the first and second spatula components from under the food item;

(3) when the first handle component is locked to the second handle component, extending the retractable fork component from the second spatula component until the retractable fork is in a first locked position;

(4) piercing a food item with the retractable fork component;

(5) removing the retractable fork component from the food item;

(6) removing the retractable fork component from the food item by retracting the retractable fork component until the food item is forced from the retractable fork component by the spatula component;

(7) retracting the retractable fork component until the retractable fork component is in a second locked position;

(8) when the first handle component is locked to the second handle component, cutting a food component using the serrated edge;

(9) when the first handle component is not locked to the second handle component, cutting a food component using the serrated edge;

(10) compressing the first handle component and the second handle component together; and locking the first handle component to the second handle component;

(11) compressing the first handle component and the second handle component together; and sliding the sliding member into either the first locking position or the second locking position;

(12) unlocking the first handle component from the second handle component; and

(13) unlocking the first handle component from the second handle component by sliding the sliding member into a position different from both the first locking position and the second locking position.

Other aspects and embodiments will be apparent to those skilled in the art after reviewing the description and drawings provided herein.

### BRIEF DESCRIPTION OF THE DRAWINGS

FIGS. 1A-2B depict an exemplary embodiment, in a retracted position.

FIGS. 3A-3B depict side views of an exemplary embodiment, in a retracted position.

FIGS. 4A-6B depict an exemplary embodiment in an extended position.

FIG. 7 depicts an exemplary embodiment in a locked position and an unlocked position.

FIG. 8 depicts an exemplary embodiment with a fork component in a retracted position and in an extended position.

FIGS. 9 and 10A-10B depict exemplary usage of a fork component of an exemplary embodiment.

FIGS. 11, 12, and 15 depict exemplary “tong” usage of an exemplary embodiment.

FIG. 13 depicts exemplary spatula usage of an exemplary embodiment.

FIG. 14 depicts exemplary cutting usage of an exemplary embodiment that comprises a knife edge portion.

FIGS. 16-20 depict exemplary embodiments having no knife edge.

### DETAILED DESCRIPTION OF CERTAIN EXEMPLARY EMBODIMENTS

Selected aspects and exemplary embodiments described herein address one or more of the above-described drawbacks of the currently available barbeque tools and are directed to a barbeque tool that combines different functionalities in a single tool.

Generally speaking, but without intending to be limited, select exemplary embodiments provide for a multifunctional barbeque tool which functions as, for example, a spatula, a fork, a pair of tongs, and, in some embodiments, a knife edge.

### Detailed Description of Select Exemplary Embodiments

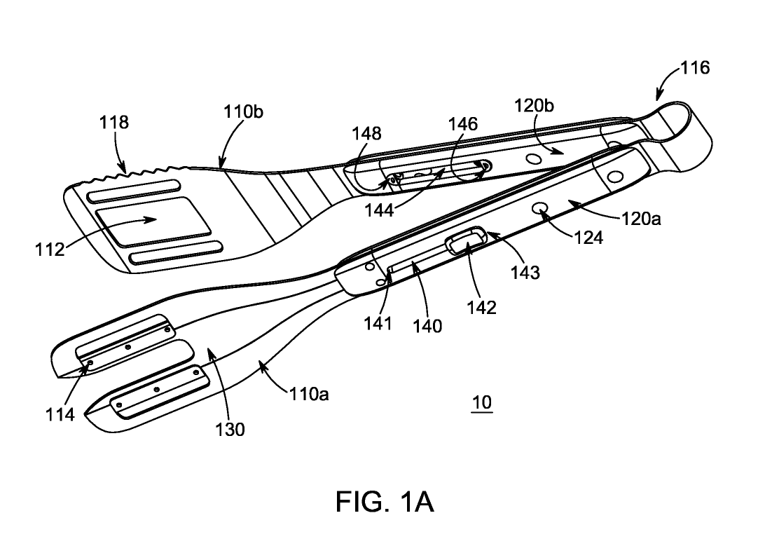

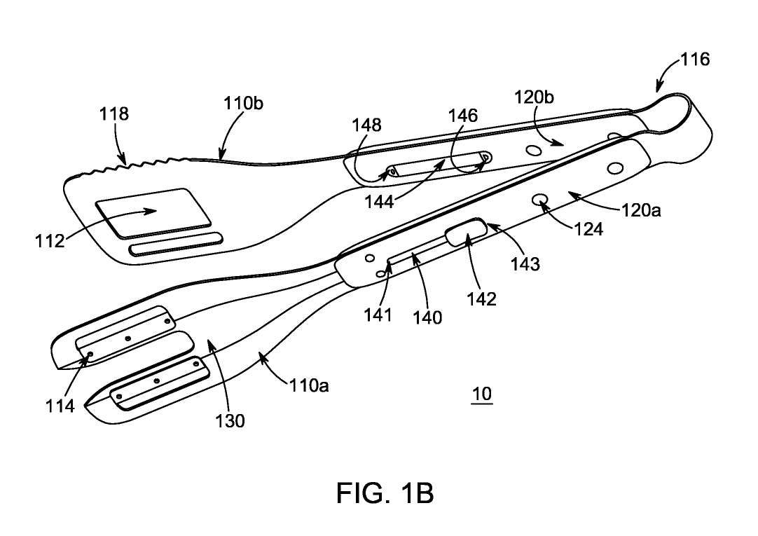

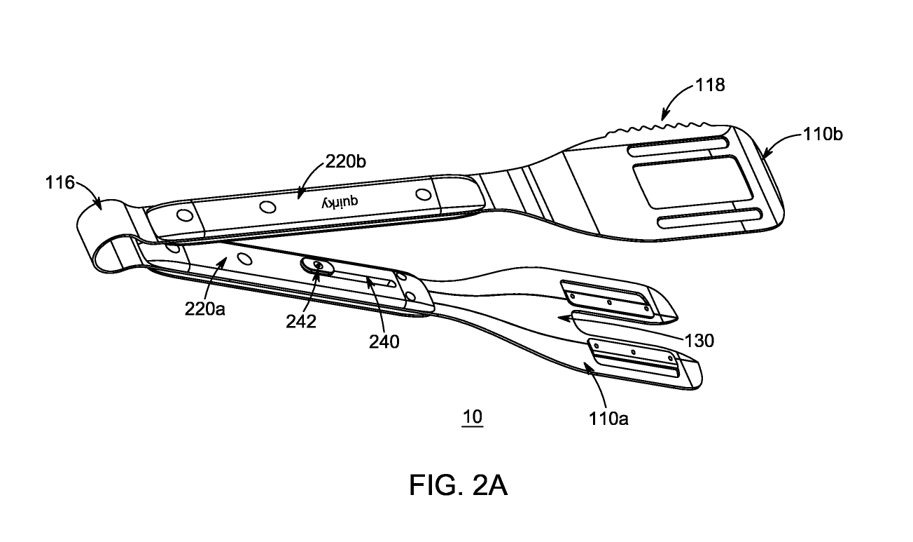

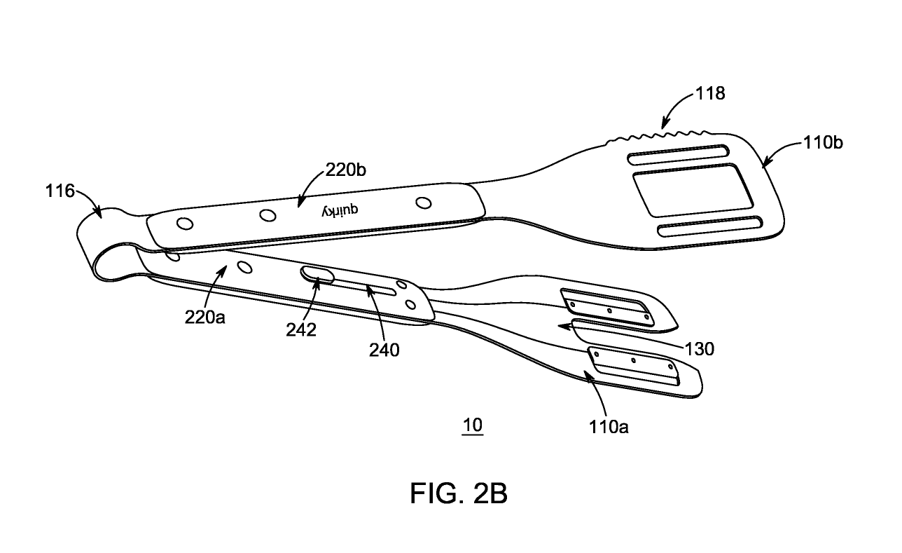

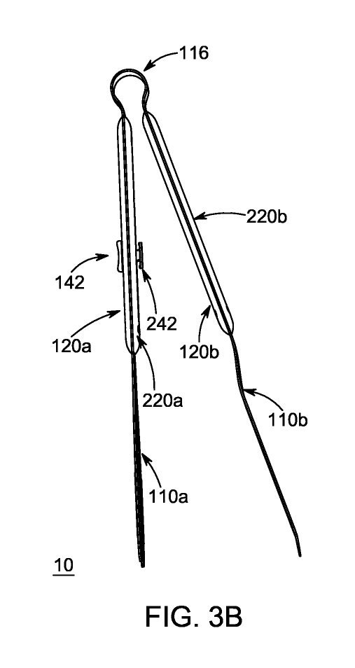

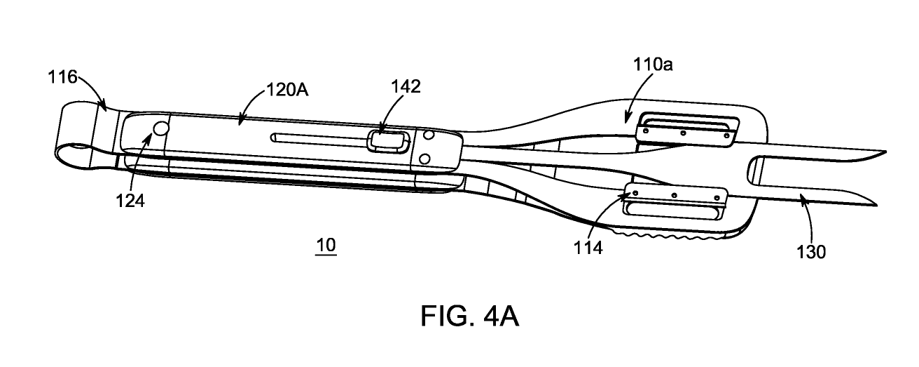

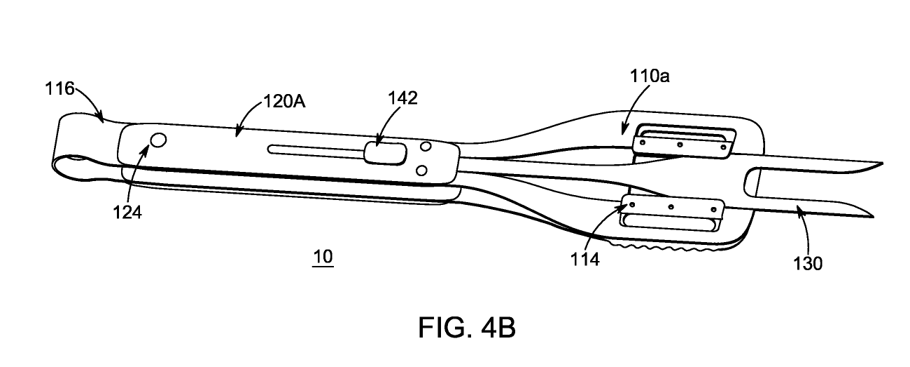

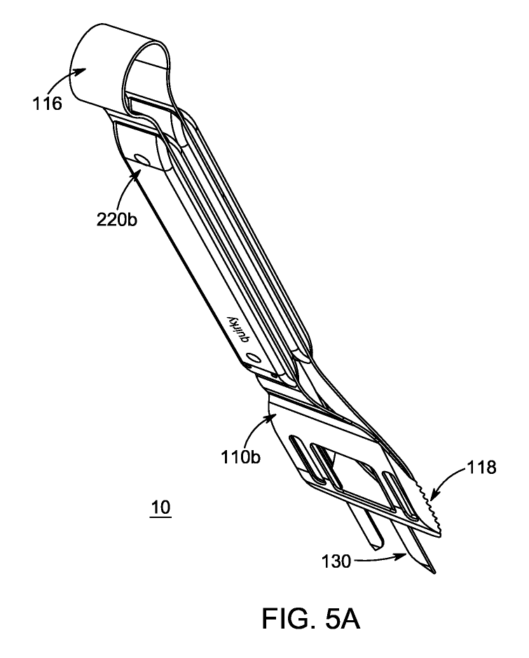

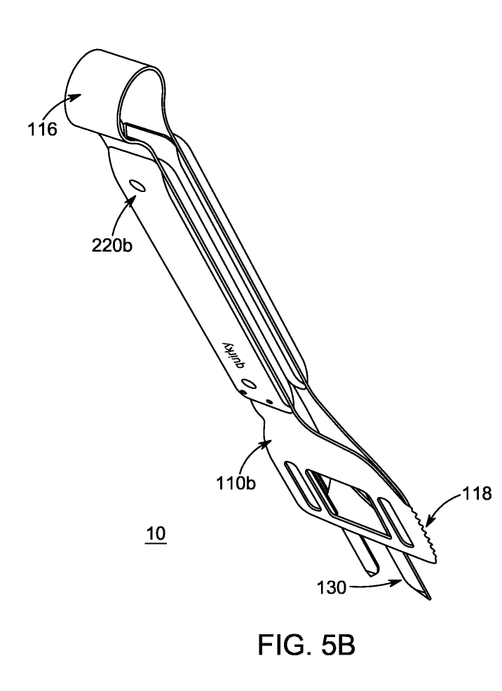

FIGS. 1A, 1B, 2A, and 2B depict an exemplary embodiment of multifunctional barbeque tool 10 that provides functionalities of a pair of tongs, a spatula, a fork, and a (serrated) knife. In particular, multifunctional barbeque tool 10 includes two members 110a and 110b having one or more openings 112 and connected by leaf spring member 116 that provides a resistance when a user presses members 110a and 110b together. Leaf spring member 116 also may be used to hang the barbeque tool for storing. Multifunctional barbeque tool 10 further includes fork 130 retracted within member 110a and configured to slide out from a retracted position (see e.g. FIG. 1A) to an extended position (see e.g., FIGS. 4A-5B) and back. Member 110b may comprise a knife edge 118.

To enable the user to hold the barbeque tool comfortably, handles 120a and 220a (see FIGS. 2) and 120b and 220b are attached on both sides of each member 110a and 110b respectively using, for example, rivets 124, although other suitable attachments may be used. In certain embodiments, handles 120 are made from wood to provide for a sturdy, non-slippery grip by the user of the barbeque tool. The handles of the barbeque tool also may house a locking/sliding mechanism to allow the user to slide fork 130 and to lock the members 110a and 110b together to form a spatula.

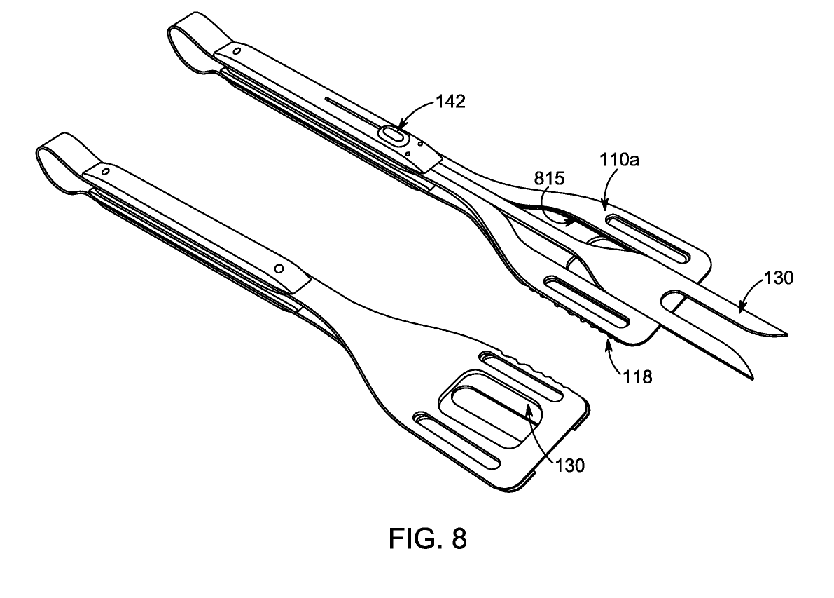

More specifically, handles 120a and 220a of member 110a define corresponding openings 140 and 240 that create a channel for housing and guiding sliding member 142. By sliding the sliding member 142 within the channel created by openings 140 and 240, from end 143 to end 141, the user causes fork 130 to slide out to the extended position and back to the retracted position, such as shown in FIGS. 4A-5B and 8. Handle 120b of member 110b defines channel 144 corresponding to the channel defined by openings 140 and 240 and formed to receive portion 242 of sliding member 142, extending above the surface of handle 220a, when members 110a and 110b are pressed together. Channel 114 houses at its ends lock mechanisms 146 and 148 respectively, each configured to automatically engage with portion 242 of sliding member 142 when the user, after pressing members 110a and 110b together, slides the sliding member 142 fully to end 141 or 143 respectively. When sliding member 142 is engaged with either of locking mechanisms 146 and 148, members 110a and 110b are locked in a closed position, with fork 130 retracted into member 110a or extended from member 110a respectively, for example as shown in FIG. 8.

In certain exemplary embodiments, member 110a is formed such as to guide the sliding movement of fork 130. For example, as shown in FIGS. 1A, 2A, and 4A, member 110a may include one or more plates 114, extending from or secured to the surface of member 110a, on one or both sides, to secure the position of fork 130 in the same plane as member 110a and facilitate smooth sliding movement of fork 130. In certain other embodiments, member 110a defines grooves for securing and guiding fork 130, for example, such as grooves 815 shown in FIG. 8. Although grooves, plates, or other means for securing and/or guiding the sliding movement of fork 130 improve the sliding movement of fork 130, they are not necessary.

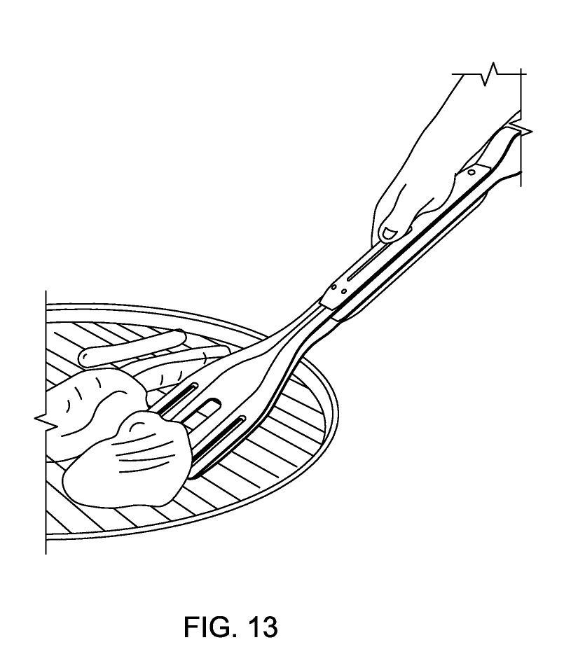

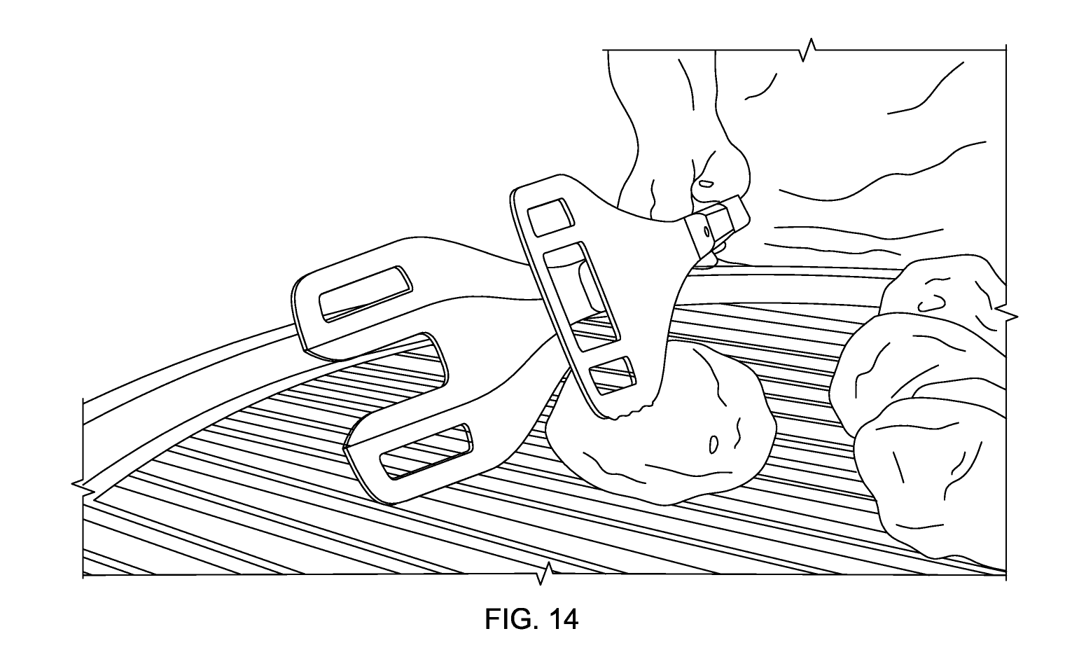

Multifunctional barbeque tool 10 may further include a knife portion to enable the user to cut food (see FIG. 14). For example, as shown in FIG. 1A, member 110b forms/includes knife edge 118. Although shown as being formed only on one side of member 110b, knife edge 118 may be formed on both sides of member 110b and/or on one or both sides of member 110a, in addition to fork 130.

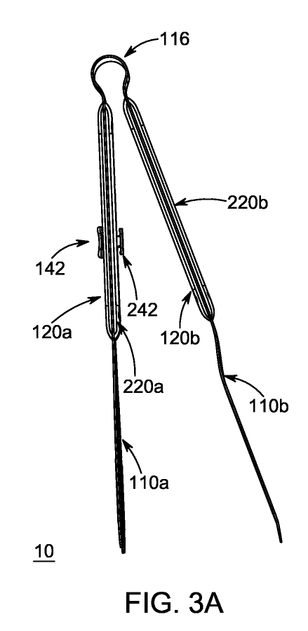

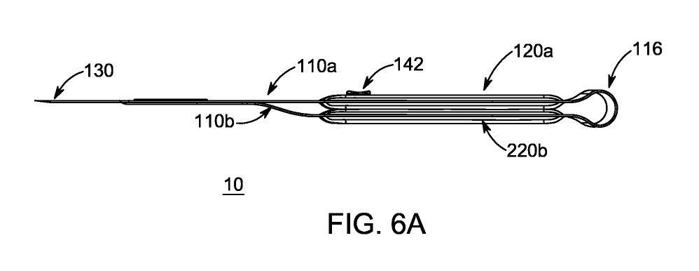

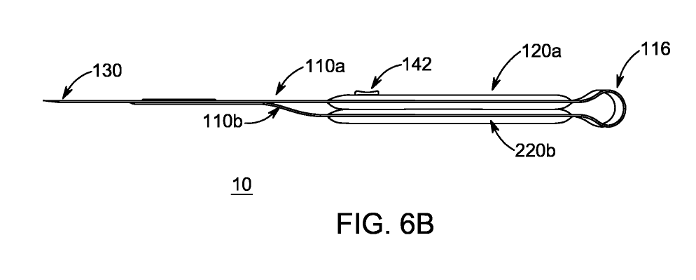

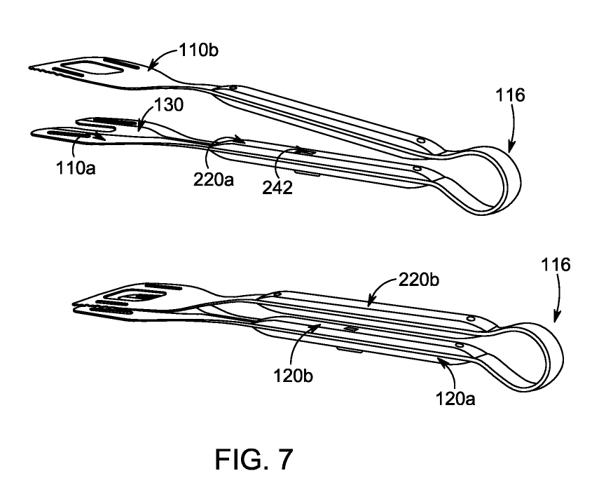

FIGS. 3A and 3B depict a side view of multifunctional barbeque tool 10. As depicted in these figures, in certain embodiments, member 110a, housing fork 130, is substantially straight, while member 110b is curved. Curving of member 110b facilitates the functionality of multifunctional device 10 as a spatula when members 110a and B are pressed together and locked, with fork 130 being in the retracted position. (see FIGS. 7 and 13). Further, in certain exemplary embodiments, the curvature of member 110b is such that when multifunctional barbeque tool is placed down, for example on a table, with member 110b facing the surface of the table, the cooking portion of multifunctional barbeque tool 10 has no contact with the surface (see FIGS. 6A and 6B), and tool 10 sits flat and stable because member 142 is on the side of tool 10 that is opposite the surface. In this manner, the user can safely put the barbeque tool down, without worrying that it would come in contact with any debris that might be on a table, or leave sauce or grease on the table.

FIGS. 1A, 1B, 2A, 2B, 3A, and 3B depict multifunctional barbeque tool 10 in an unlocked position with fork 130 in the retracted position, where the barbeque tool is ready to be used as tongs. As discussed above, leaf spring member 116 provides resistance when the user presses members 110a and 110b together, thereby improving and enhancing a user's ability to grab and turn food while using multifunctional barbeque tool 10 as tongs.

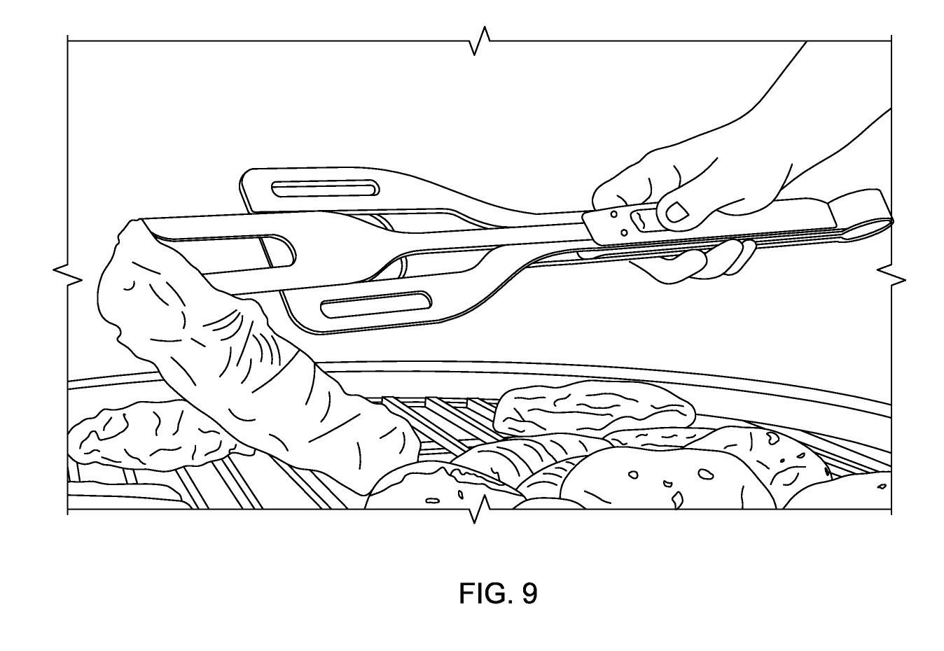

FIGS. 4A, 4B, 5A, 5B, 6A, and 6B depict an exemplary embodiment of multifunctional barbeque tool 10 in the locked position and fork 130 in the extended position, where the barbeque tool is ready to be used as a fork. To transform multifunctional barbeque tool 10 from the unlocked position with fork 130 in the retracted position (from functioning as tongs) to the locked position with fork 130 in the extended position (to functioning as a fork), the user merely needs to press members 110a and 110b together and slide sliding member 142 within opening 140 to end 141. By sliding the sliding member 142 to end 141 fully, lock mechanism 148 automatically engages with portion 242, thereby locking members 110a and 110b together and forming a fork with a single handle (see FIG. 9). In this manner, with one quick motion and using only one hand, the user can easily transform multifunctional barbeque tool 10 from serving as tongs to serving as a fork and back.

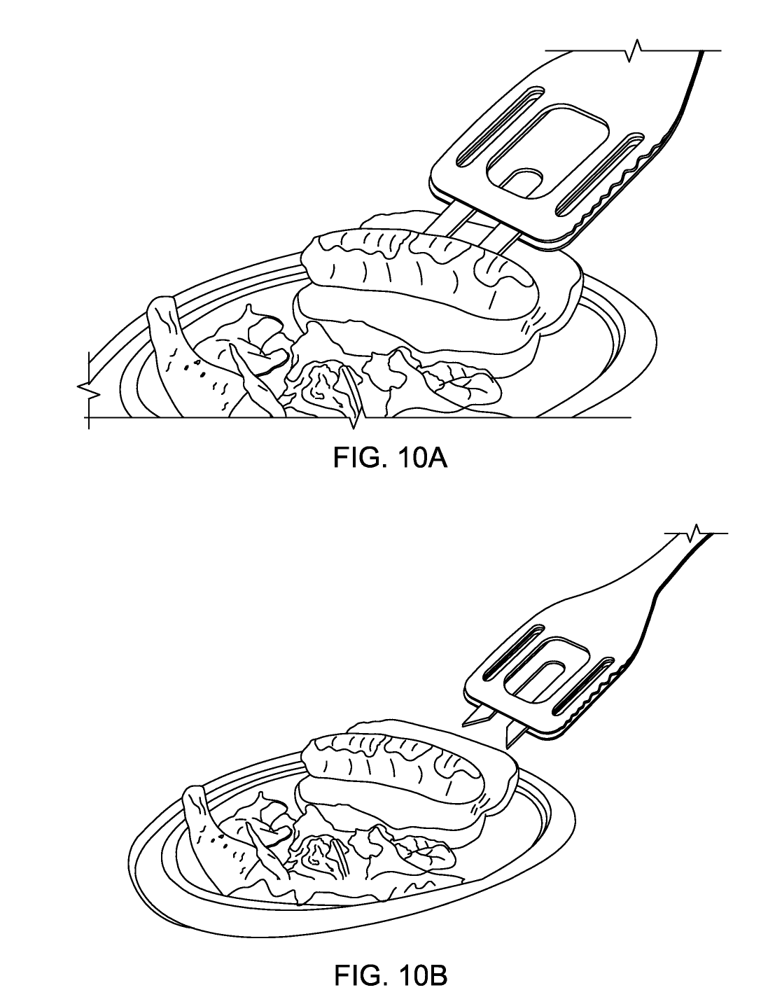

Further, as shown in FIGS. 10A and 10B, sliding member 142 may be used to facilitate removal of the food from the fork and placement of the food on a plate, bun, and the like. After forking food, such as a hot dog, with multifunctional barbeque tool 10, the user can start sliding the sliding member 142 back towards end 143 so that when the food comes in contact with the end of members 110a and 110b, members 110a and 110b push the food of fork 130 as the user continues sliding the sliding member 142 towards end 143.

FIG. 7 depicts multifunctional barbeque tool 10 of certain exemplary embodiments being transformed from the unlocked position with fork 130 in the retracted position (from functioning as tongs) to the locked position with fork 130 remaining in the retracted position (to functioning as a spatula). To transform multifunctional barbeque tool 10 from functioning as tongs to functioning as a spatula, the user merely needs to press members 110a and 110b together and slide sliding member 142 within opening 140 fully into end 143. When sliding member 142 is at end 143, lock mechanism 146 is engaged with portion 242, thereby locking members 110a and 110b together and forming a spatula with a single handle, ready to lift food from the barbeque grill (see FIG. 13). In this manner, with one quick motion and using only one hand, the user can easily transform multifunctional barbeque tool 10 from serving as tongs to serving as a spatula (or for storing) and back.

FIG. 8 depicts multifunctional barbeque tool 10 of certain exemplary embodiments being transformed from the locked position with fork 130 in the retracted position (from functioning as a spatula) to the locked position with fork 130 in the extended position (to functioning as a fork) and back. The user can easily achieve such a transformation by simply sliding the sliding member 142 within opening 140 from end 143 to end 141 and back, where members 110a and 110b are automatically locked when sliding member is fully at either of ends 141 and 143.

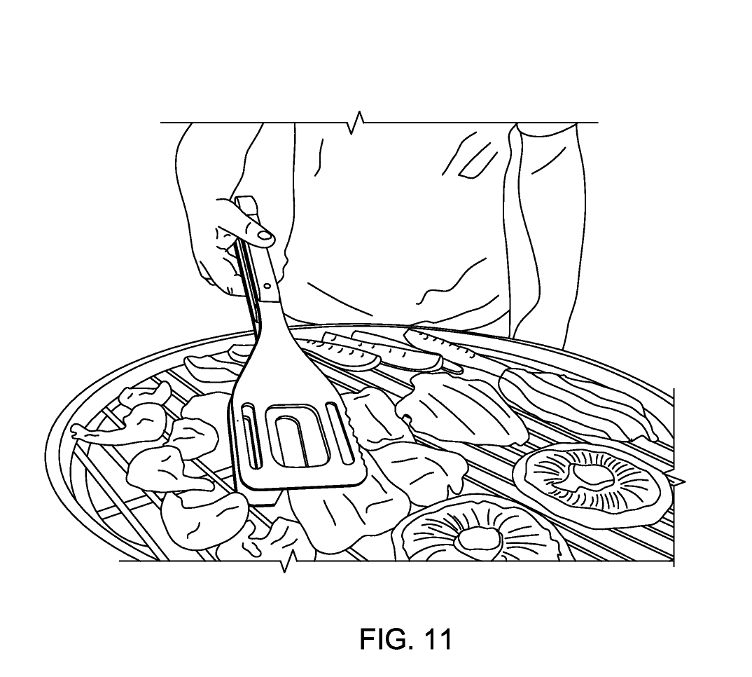

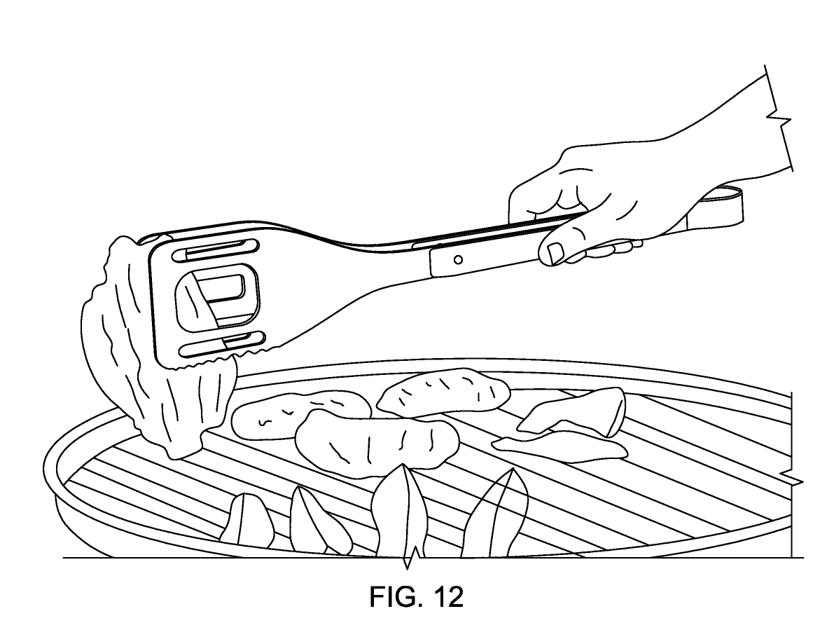

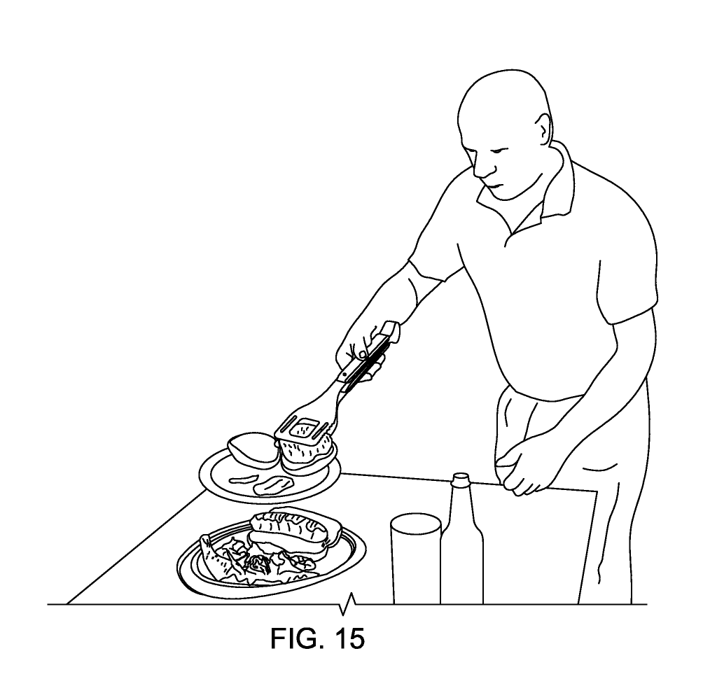

FIGS. 11, 12, and 15 depict multifunctional barbeque tool 10 of certain exemplary embodiments being used as tongs.

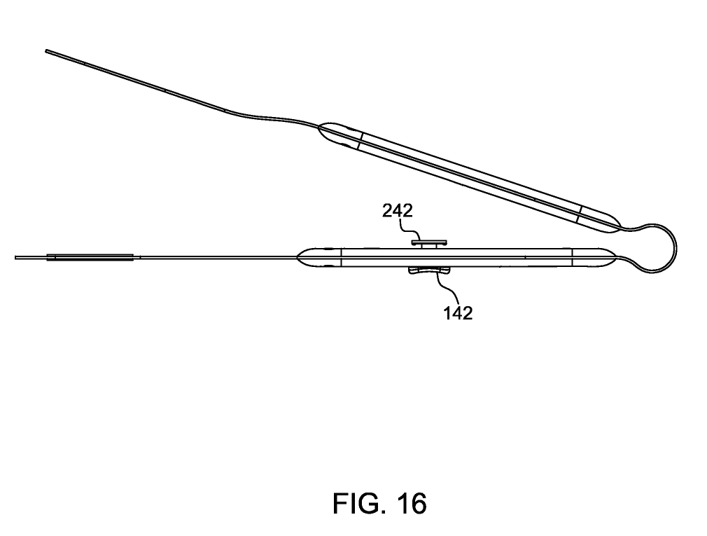

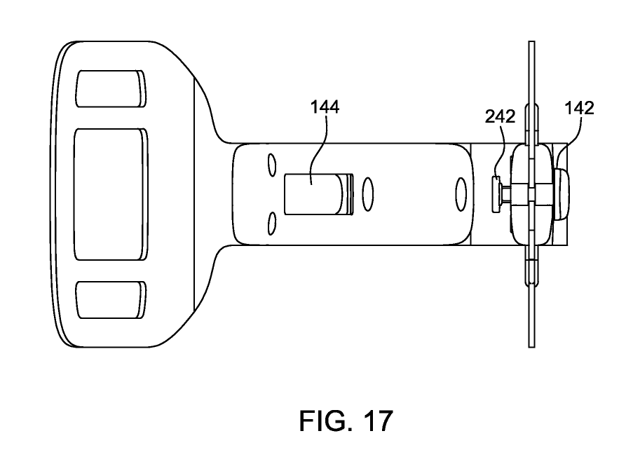

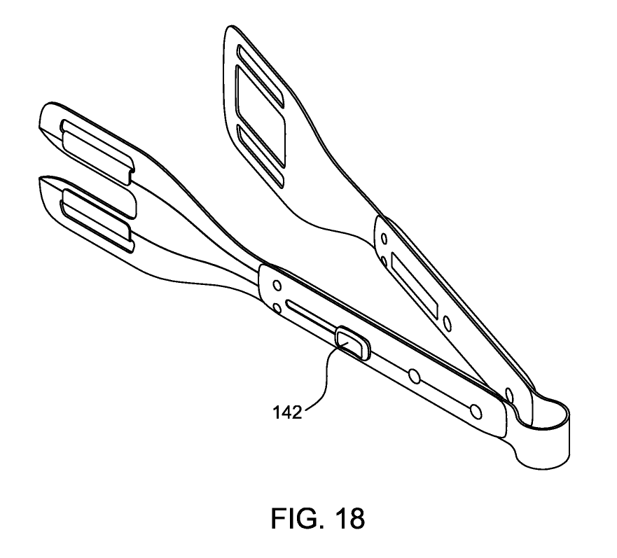

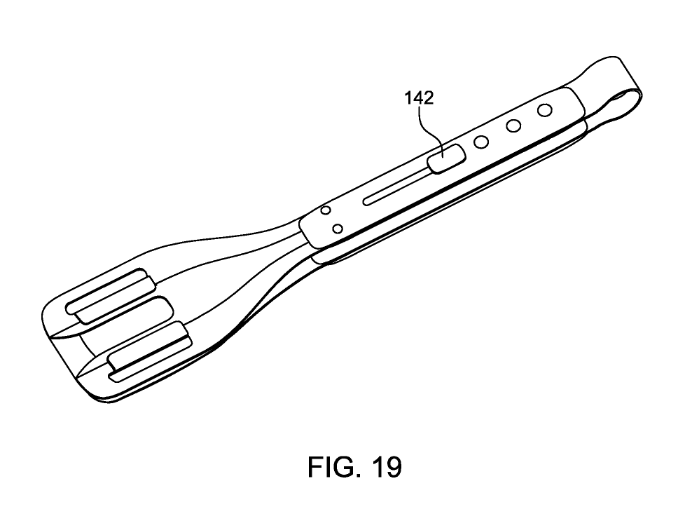

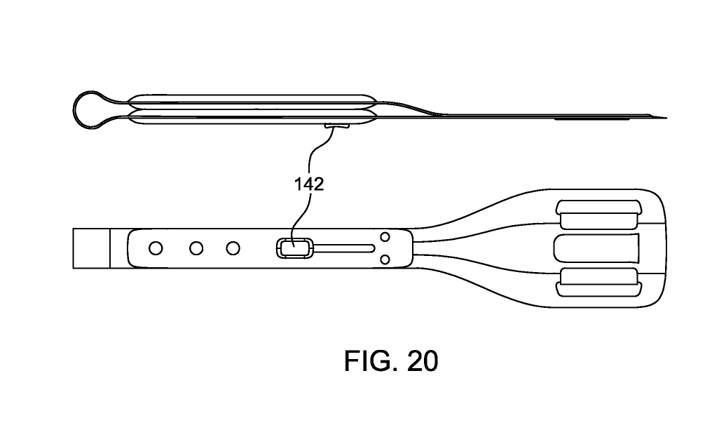

In further exemplary embodiments (see FIGS. 16-20), handles 120 are made of heat-resistant plastic, and the fork-locking mechanism is incorporated into the plastic handle. An example of appropriate material for the handles is POM (polyoxymethylene), which provides high abrasion resistance, a low coefficient of friction, and high heat resistance.

Also, the embodiment depicted in FIGS. 16-20 do not comprise a knife-edge portion.

Embodiments described herein provide for a multifunctional barbeque tool that can functions as tongs, a spatula, a fork, and/or a knife and can be transformed from one functionality to another by a user with an easy, single-motion movement. Various materials may be used to manufacture the described multifunctional barbeque tool. In certain embodiments, the multifunctional barbeque tool is made from metal, such as stainless steel, with wooden handles. As will be recognized by those skilled in the art, various other materials (such as plastic for the handles) also may be used in various embodiments.

Further, in an exemplary embodiment, the multifunctional barbeque tool may have the following dimensions: 20 inches long with the fork retracted and 22.5 inches long with the fork extended; 3.5 inches wide spatula, 0.875 inches wide handles; 1.875 inches height with handles locked together and 3.5 inches height when members (tongs) are open. These measurements are, of course, completely exemplary.

While certain exemplary aspects and embodiments have been described herein, many alternatives, modifications, and variations will be apparent to those skilled in the art. Accordingly, exemplary aspects and embodiments set forth herein are intended to be illustrative, not limiting. Various modifications may be made without departing from the spirit and scope of the inventive disclosure.

We claim:

1. An apparatus comprising
a first handle component comprising a first end and a second end; and
a second handle component comprising a third end and a fourth end,
wherein said first end is connected to said third end via a spring clip,
wherein said second end is connected to a first spatula component,
wherein said fourth end is connected to a second spatula component, and
wherein said first handle component is operable to be locked to said second handle component.

2. An apparatus as in claim 1, wherein said second spatula component and said second handle component comprise a retractable fork component.

3. An apparatus as in claim 1, wherein said first spatula component comprises a serrated edge.

4. An apparatus as in claim 1, wherein said first handle component is operable to be locked to said second handle component via a sliding member.

5. An apparatus as in claim 4, wherein said sliding member has a first locking position and a second locking position.

6. An apparatus as in claim 5, wherein when said sliding member is in said first locking position, said fork component is in an extended position, and when said sliding member is in said second locking position, said fork component is in a retracted position.

7. A method of using an apparatus as in claim 1, said method comprising, when said first handle component is not locked to said second handle component:
positioning said apparatus such that a food item is located between said first spatula component and said second spatula component;
compressing said first handle component and said second handle component together, so that said first spatula component and said second spatula component press against said food item with sufficient force to hold said food item; and
releasing pressure on said first handle component and said second handle component in an amount sufficient to release said food item from said first spatula component and said second spatula component.

8. A method of using an apparatus as in claim 1, said method comprising, when said first handle component is locked to said second handle component:
positioning said first and second spatula components under a food item; and
removing said first and second spatula components from under said food item.

9. A method of using an apparatus as in claim 2, said method comprising, when said first handle component is locked to said second handle component, extending said retractable fork component from said second spatula component until said retractable fork is in a first locked position.

10. A method as in claim 9, further comprising piercing a food item with said retractable fork component.

11. A method as in claim 10, further comprising removing said retractable fork component from said food item.

12. A method as in claim 11, wherein removing said retractable fork component from said food item comprises retracting said retractable fork component until said food item is forced from said retractable fork component by said spatula component.

13. A method as in claim 9, further comprising retracting said retractable fork component until said retractable fork component is in a second locked position.

14. A method of using an apparatus as in claim 3, said method comprising, when said first handle component is locked to said second handle component, cutting a food component using said serrated edge.

15. A method of using an apparatus as in claim 3, said method comprising, when said first handle component is not locked to said second handle component, cutting a food component using said serrated edge.

16. A method of using an apparatus as in claim 1, said method comprising:
compressing said first handle component and said second handle component together; and
locking said first handle component to said second handle component.

17. A method of using an apparatus as in claim 5, said method comprising:
compressing said first handle component and said second handle component together; and
sliding said sliding member into either said first locking position or said second locking position.

18. A method of using an apparatus as in claim 1, said method comprising unlocking said first handle component from said second handle component.

19. A method of using an apparatus as in claim 5, said method comprising unlocking said first handle component from said second handle component by sliding said sliding member into a position different from both said first locking position and said second locking position.
